(19) United States
(12) Patent Application Publication
(10) Pub. No.: US 2009/0114642 A1
(43) Pub. Date: May 7, 2009

(54) MICROWAVE OVEN WITH A TRAY MOVING IN AN ORBITAL PATTERN

(75) Inventors: WAI HANG LOUIE, HONG KONG (CN); LIANG HUI ZHENG, SHEN ZHEN (CN); ULF ERIK NORDH, NORRKOPING (SE); HAKAN CARLSSON, NORRKOPING (SE)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/264,974

(22) Filed: Nov. 5, 2008

(30) Foreign Application Priority Data
Nov. 6, 2007 (EP) 07120043.0

(51) Int. Cl. H05B 6/80

(52) U.S. Cl. 219/725

(57) ABSTRACT

A microwave oven includes a heating cavity, a tray for supporting foodstuff to be heated inside the cavity, a driver including a motor and a shaft protruding into the cavity for moving the tray along a predetermined pattern, and a supporting frame with rollers interposed between the bottom of the heating cavity and the tray. The supporting frame comprises a first group of rollers adapted to be guided on the bottom of the heating cavity along a first direction, and a second group of rollers adapted to be guided on a lower surface of the tray along a second direction substantially perpendicular to the first direction, so that the overall movement of the tray is an orbital movement.

### BACKGROUND OF THE INVENTION

1. Field of the Invention

The present invention relates to a microwave oven comprising a heating cavity, a tray for supporting foodstuff to be heated inside the cavity, a driver having a motor outside the cavity and a shaft protruding inside the cavity for moving the tray along a predetermined pattern, and a support interposed between the bottom of the cavity and the tray.

2. Description of the Related Art

Such a microwave oven is disclosed by U.S. Pat. No. 6,512,213, in which the tray is linearly reciprocated in the right and left direction within the heating cavity. This document discloses a motor with a rotational force converting the rotation to a linear reciprocating motion by means of an eccentric protrusion in the rotating member communicating with a groove in the tray.

Even if such linear reciprocating motion of the tray allows solving the technical problem of an efficient use of the space within the rectangular heating cavity, nevertheless the linear movement is not sufficient to guarantee a uniform heating of the foodstuff which is comparable with the result obtained by using a traditional circular rotating tray.

EP-A-1677579 discloses a microwave oven in which the linear movement of a first rectangular tray is combined with the rotational movement of a second circular tray. The “combined” movement of the second tray allows obtaining a more uniform heating of foodstuff, but the space inside the cavity is not used efficiently and the complexity (and therefore the cost) of the system is high.

### SUMMARY OF THE INVENTION

It is an aspect of the present invention to provide a microwave oven of the type mentioned at the beginning of the description that allows a very good efficiency in using the space within the heating cavity and that guarantees at the same time a uniform heating of foodstuff, comparable or even better to that obtainable with a traditional circular rotating tray.

The above aspect is reached thanks to the features listed in the appended claims.

### BRIEF DESCRIPTION OF THE DRAWINGS

Other aspects, features and advantages of a microwave oven according to the present invention will become more apparent from the following detailed description when taken in conjunction with the appended drawings in which:

FIG. 1 is a perspective view of a microwave oven according to the present invention;

FIG. 2 is an exploded view of the components installed in the cavity of the microwave oven of FIG. 1 according to a first embodiment of the invention;

FIG. 3 is an enlarged schematic cross-section taken along line III-III of FIG. 1 according to a second embodiment of the invention;

FIG. 4 is a perspective view of the tray used in the embodiment of FIG. 3, on the lower side thereof;

FIG. 5 is a perspective view of the bottom wall of the heating cavity according to the second embodiment of the invention; and

FIG. 6 is a perspective view of a rotating bifurcated arm used for moving the tray in the second embodiment of the invention.

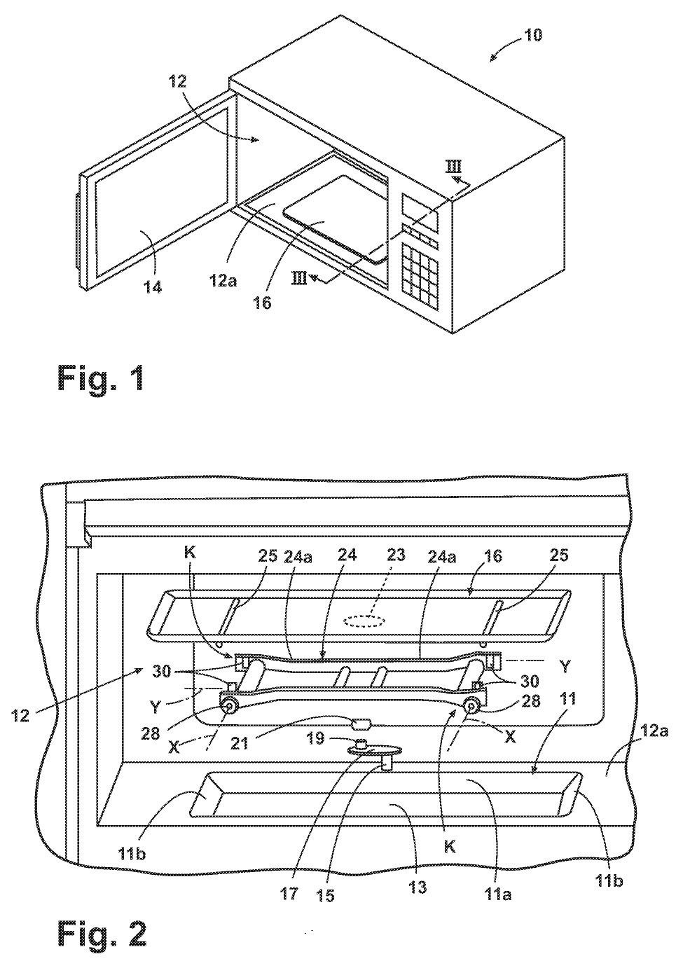

### DETAILED DESCRIPTION OF THE PREFERRED EMBODIMENTS

With reference to the drawings, a microwave oven 10 has a heating cavity 12 closed by a door 14 and in which a rectangular tray 16 is placed for supporting the food for heating/cooking. The tray 16 is designed to move in a non-linear orbit to give an even heating/cooking of the food by the heat source or microwave energy in the microwave oven, as it will be clear from the following technical description.

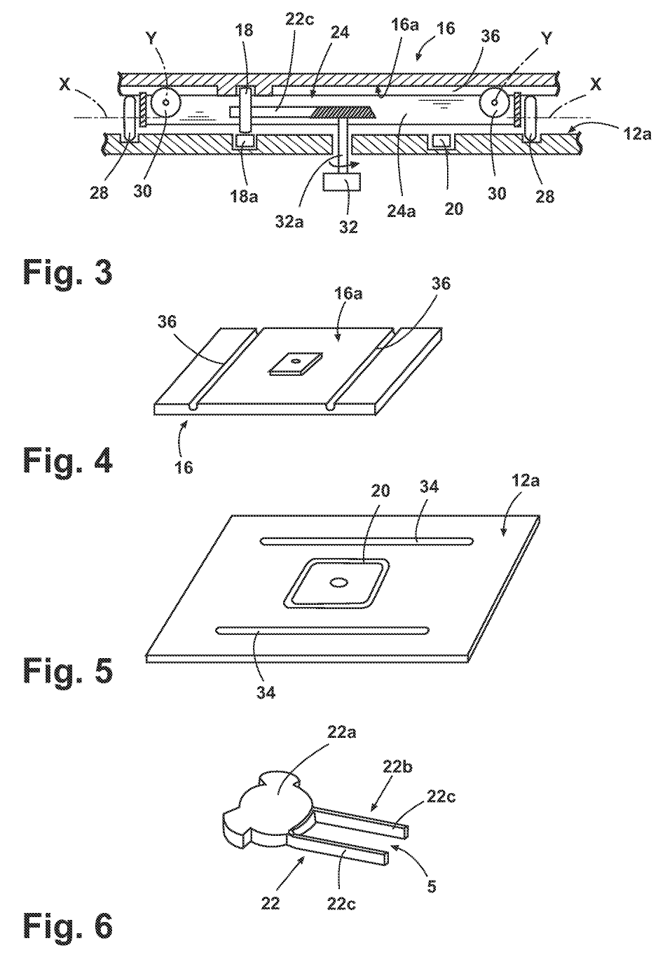

According to a first embodiment of the invention (shown in FIG. 2), the heating cavity 12 present a bottom surface 12a with a rectangular recess 11 in which transversal edges 11a and longitudinal edges 11b are defined. In the center of the recess 11, the cavity 12 presents a hole 13 for the passage of a shaft 15 on which an arm 17 is fixed. On one end of the arm 17 far from the shaft 15 (to which an electric motor, not shown in FIG. 2, is attached) a pin 19 is fixed which, with the interposition of a bush 21, is rotatably inserted in a central seat 23 provided in the lower surface of the tray 16, the term “lower” being used with reference to the working position of the tray 16 installed in the oven. The shaft 15, the arm 17 and the pin 19 are part of a single piece obtained, for instance, by means of injection moulding. The bush 21 is snap engaged on the pin 19. A double side roller rack 24 is used as a supporting rack for the rectangular tray 16. The rack 24 has a rectangular annular frame 24a with corner zones K for rotatably supporting a first group of lower rollers 28 and a second group of upper rollers 30, the terms “lower” and “upper” being used with reference to the position of the rollers (FIG. 3) compared to the centre plane of the frame 24a). Each roller 28 of the first group of four lower rollers (with reference to the installed configuration in the oven 10) have horizontal longitudinal axis X while each roller of the second group of upper rollers 30 have horizontal transversal axis Y. One alternative to the double side roller rack 24 is to use a single side roller rack equipped with castor wheels. The axis X and Y of rollers 28 and 30 respectively are slightly offset in the vertical direction so that the first group of rollers 28 are supported on the bottom surface 12a of the oven cavity and are guided along the transversal edges 11a of the recess 11, while the second group of rollers 30 support the lower surface 16a of the tray 16 and are guided along longitudinal ribs 25.

When the arm 17 is rotating, the tray 16 is moved along an orbital circular pattern while the rack 24 is moved back and forth along a transversal direction. The rack 24 prevents the tray 16 from rotating around its own axis, rather its axis rotates around the axis of the arm 17 (defined by the shaft 15).

The second embodiment of the invention, shown in FIGS. 3 to 6, allows a motion of the tray 16 which may be different from an orbital circular motion, for instance a rectangular orbital motion. In FIGS. 3 to 6 the same reference numerals used in the description of the first embodiments, for identical or similar components, have been used as well.

According to the second embodiment of the invention, the tray 16 presents, on its bottom surface 16a, a roller pin 18 attached to the centre thereof. The roller pin 18 is guided by an annular track 20 at the cavity bottom 12a. In the drawings the track 20 has a rectangular shape, but it can have different shapes, including an elliptical shape. A bifurcated turning arm 22 is designed to push the roller pin runner 18 in the annular track 20. The turning arm 22 has a central portion 22a which can be used in connection with traditional (not orbital) rotating trays, and a side fork-shaped portion 22b with two parallel and spaced arms 22c defining a slot S in which the roller pin 18 is adapted to radially slide. There is a motor 32 (FIG. 3) below the cavity bottom 12a. The motor shaft 32a protrudes through the hole 13 in the cavity bottom and the turning arm 22 is fixed to the motor shaft 32a. The tray 16 is resting on the double side roller rack 24 which may be identical to the rack used in the first embodiment of the invention. The four lower or rollers 28 of the rack 24 allow a left/right transversal motion (with reference to a user facing the oven cavity 12) with the wheels 28 following left/right linear tracks 34 in the cavity bottom 12a (or edges 11a of a rectangular recess 11, as shown in the first embodiment). Further, the four upper wheels 30 of the rack 24 allow a front/back longitudinal motion with the wheels or rollers 30 following front/back tracks 36 on the lower face 16a of the tray 16 (or ribs 25 as shown in the first embodiment). The roller pin 18 is centrally attached on the lower side 16a of the tray 16. A lower end of the roller pin 18 is provided with a wheel 18a guiding the roller pin 18 inside the track or groove 20 when the arm 22 is turning during the rotation of the motor shaft 32a. During the motor rotation, the tray 16 will move e.g. to the far left, then moving towards the front to the end of the track, then moving to the right to the end of that track, next turn and move to back, therefore following an orbital rectangular pattern. The roller rack 24 is only moving left/right in relation to the cavity 12, as in the first embodiment of the invention. The tray 16 is moving front/back in relation to the roller rack 24.

By changing the shape of the annular track 20 to an elliptical one, it is possible to obtain an elliptical orbital motion (not shown). In a further embodiment of the invention (not shown) the roller rack 24 may have four castor wheels only that can move/roll in any direction. Also in this embodiment the tray 16 is resting on the roller rack and has the roller pin attached to the lower side of the tray. The roller pin 18 is sliding inside the slot S of the turning arm 22. The lower end 18a of the roller pin 18 is following an elliptical track (not shown) in the cavity bottom 12a close to the motor shaft/turning arm.

The shape of the turning arms 17 and 22 is such that the tray 16 and the roller rack 24 can be easily replaced by a circular traditional tray and by a rotating traditional ring with rollers interposed between the bottom of the cavity and the tray.

This is advantageous when small portions of food have to be heated/cooked.

1. A Microwave oven comprising:
a heating cavity;
a tray for supporting foodstuff to be heated inside the cavity;
a driver including a motor and a shaft protruding into the cavity for moving the tray along a predetermined pattern; and
a support interposed between the bottom of the heating cavity and the tray, wherein:
the support having (1) a first group of rollers adapted to be guided on the bottom of the heating cavity along a first direction, and (2) a second group of rollers adapted to be guided on a lower surface of the tray along a second direction substantially perpendicular to the first direction.

2. The microwave oven according to claim 1, wherein the driver further comprises a rotating arm mounted in a central seat of the lower surface of the tray.

3. The microwave oven according to claim 1, wherein the first group of rollers are guided along parallel edges of a quadrangular recess in the bottom of the heating cavity.

4. The microwave oven according to claim 1, wherein the second group of rollers are guided along ribs provided in the lower surface of the tray.

5. The microwave oven according to claim 1, wherein the driver further comprises:
a pin fixed at one end to the lower surface of the tray and having a second end slidably guided in an annular track provided on the bottom of the cavity; and
a rotary arm fixed to the shaft and adapted to drive the pin that is radially slidable along the arm so that the tray is moved according to the pattern of the annular track.

6. The microwave oven according to claim 5, wherein the annular track is provided in the bottom of the cavity.

7. The microwave oven according to claim 5, wherein the annular track has a quadrangular shape.

8. The microwave oven according to claim 5, wherein the annular track has an elliptical shape.

9. The microwave oven according to claim 5, wherein the bottom of the cavity includes a first pair of linear tracks and the lower surface of the tray includes a second pair of linear tracks perpendicular to the first pair, the support further comprises a frame on which the first group of rollers are freely rotatable and are adapted to be guided in the first pair of linear tracks and on which the second group of rollers are freely rotatable and are adapted to be guided in the second pair of linear tracks.

10. The microwave oven according to claim 9, wherein the frame of the support has a quadrangular planar shape with corner zones where the rollers are mounted.
